(19) United States
(12) Patent Application Publication
(10) Pub. No.: US 2024/0386356 A1
(43) Pub. Date: Nov. 21, 2024

(54) DATABASE SYSTEM AND METHOD FOR DETERMINING AND UTILIZING ENVIRONMENTAL METRICS

(71) Applicant: SAP SE, Walldorf (DE)

(72) Inventors: Miklos Zoltan Szabo, Sunnyvale, CA (US); Matthias Saettele, Neustadt-an-der-Weinstrasse (DE); Jochen Mayerle, Flein (DE); Christoph Ehrhardt, Mannheim (DE); Stefan Feickert, Birkenau (DE); Bastian Distler, Ketsch (DE); Christoph Ernst, Heidelberg (DE); Edrilan Berisha, Dudenhofen (DE); Florence Jungnickel, Paris (FR)

(21) Appl. No.: 18/665,299

(22) Filed: May 15, 2024

Related U.S. Application Data
(60) Provisional application No. 63/466,892, filed on May 16, 2023.

(51) Int. Cl. G06Q 10/0637; G06F 16/18

(52) U.S. Cl. CPC G06Q 10/06375; G06F 16/1815

(57) ABSTRACT

Various examples are directed to systems and methods of using a database management system (DBMS) to post a transaction. An enterprise resource planning (ERP) application may receive first transaction data associated with a first transaction including acquisition of a first component of a first component type. The first transaction data may describe an indicator of the first component, a cost of the first component of a first component type, and a first environmental metric associated with the first component. The ERP application may write a first transaction entry to a universal journal table of the DBMS, the first transaction entry comprising a description of the first transaction, and a component breakdown key. The ERP application may also write a first component breakdown entry to a component breakdown table of the DBMS.

### CROSS-REFERENCE TO RELATED APPLICATIONS

This application claims the benefit of U.S. Provisional Application No. 63/466,892, filed May 16, 2023, entitled “DATABASE SYSTEM AND METHOD FOR DETERMINING AND UTILIZING ENVIRONMENTAL METRICS,” which is incorporated herein by reference in its entirety.

### BACKGROUND

A database management system (DBMS) can be implemented as part of a suite of software applications that execute together. For example, the DBMS may support various client processes that utilize the DBMS to manage data. In some examples, a DBMS is implemented with a suite of processes that implement an enterprise resource planning (ERP) software solution. An ERP software solution may include one or more ERP applications. The ERP applications execute in conjunction with the DBMS to manage various different aspects of business operations. An example ERP software solution is the S/4 HANA product available from SAP SE of Walldorf, Germany.

### BRIEF DESCRIPTION OF DRAWINGS

The present disclosure is illustrated by way of example and not limitation in the following figures.

FIG. 1 is a diagram showing one example of an environment comprising an accounting enterprise resource planning (ERP) system and an environmental accounting hub system 104.

FIG. 2 is a diagram showing one example of an environment illustrating the accounting ERP system and environmental accounting hub system in conjunction with additional components.

FIG. 3 is a diagram showing one example environment comprising a database management system implementing an environmental ledger.

FIG. 4 is a workflow diagram showing one example of a process flow that may be executed in the environment of FIG. 3.

FIG. 5 is a workflow diagram showing another example of a process flow that may be executed in the environment.

FIG. 6 is a diagram of an output screen showing example environmental outputs, such as the environmental outputs.

FIG. 7 is a diagram showing one example of an environment for generating environmental metrics using distributed database systems.

FIG. 8 is a flowchart showing one example of a process flow that may be implemented by an accounting ERP application to post a transaction entry to a universal journal table.

FIG. 9 is a flowchart showing one example of a process flow that may be executed, for example, by an accounting ERP application or other component to update the component breakdown table.

FIG. 10 is a flowchart showing one example of a process flow 1000 that may be executed by an environmental accounting hub system or hub application executing thereon.

FIG. 11 is a flowchart showing another example of a process flow 1100 that may be executed by an environmental accounting hub system or hub application executing thereon.

FIG. 12 is a diagram illustrating an example of an in-memory DBMS that may be used to implement table privilege management, for example, as described herein.

FIG. 13 is a diagram illustrating an example of an index server of the in-memory DBMS of FIG. 12.

FIG. 14 is a diagram illustrating one example of the request processing and execution control of the DBMS of FIG. 13.

FIG. 15 is a block diagram showing one example of a software architecture for a computing device.

FIG. 16 is a block diagram of a machine in the example form of a computer system within which instructions may be executed for causing the machine to perform any one or more of the methodologies discussed herein.

### DETAILED DESCRIPTION

An enterprise resource planning (ERP) application generates and utilizes the data stored at the one or more database management systems (DBMS) to perform different enterprise operations. For example, an ERP application supporting a human resources operation may store employee records at the DBMS. The human resources ERP application may perform various tasks such as, for example, managing payroll, benefits, and the like. An example ERP application supporting accounting may use records managed by the DBMS to perform various accounting-related tasks such as posting transactions, reconciling accounts, and/or the like. An ERP application supporting operations may manage and generate various purchase orders, shipping orders, and/or the like to manage manufacturing or other operations.

In some examples, ERP applications and associated DBMSs may be specifically arranged to perform ERP application operations in a way that decreases processing delay, increases the efficiency of computing device resource usage, and/or the like. In some examples, an ERP application supporting financial accounting may be arranged to utilize a universal journal table. A universal journal table can include columns or fields for multiple different kinds of accounting journal entries, often leading to a table with a large number of columns. For example, the ACDOCA table provided by the HANA and S/4 HANA database systems can include several hundred columns. The large number of columns in the universal journal table may allow multiple different types of accounting journal entries to be included as table records in the same table, thus providing flexibility to customize the universal journal table for different enterprises and different business units within enterprises. In some examples, the size of the universal journal table (e.g., the number of columns) can lead to larger processing times for write operations, queries, and/or the like. This can be mitigated, in some examples, by using an in-memory database such as the HANA DBMS available from SAP SE of Walldorf, Germany. For example, when the tables are stored in a random access memory (RAM), read and write times may be reduced, thus lessening the delay and resource usage associated with tables having a large number of columns. For example, the DBMS may quickly and efficiently generate views of the universal journal table, where the views focus on portions of the table including information relevant to a query or queries.

It is desirable to leverage business data stored at DBMSs and managed by ERP applications to quickly and accurately derive environmental metrics. Environmental metrics may describe environmental costs and/or benefits associated with business operations such as manufacturing. Example environmental metrics include carbon footprint metrics, resource use metrics, waste metrics, and/or the like. For example, some regulatory authorities have implemented environmental taxes, such as carbon taxes, other emission certificates, or other regulatory arrangements in which enterprises are responsible financially for various environmental metrics associated with their operations.

Carbon footprint metrics describe the amount of greenhouse gases, such as carbon dioxide, emitted or caused to be emitted by an individual, organization, or activity. For businesses that provide products, it may be desirable to determine detailed carbon footprint metrics associated with their products. For example, these detailed carbon footprint metrics can be used to consider the costs of emission certificates or other mechanisms created by government regulatory agencies for assigning costs to greenhouse gas emissions. For example, under such regulatory regimes, understanding the carbon footprint of a product may be necessary to determine the total financial impact of the product, including whether it is cost-effective to continue to produce the product.

Resource use metrics can indicate resources that are consumed to generate and/or provide a product and/or service. Example resources can include electricity, water, and/or the like. Resource use metrics can measure resource use using various different units. For example, electricity usage may be measured in kilowatt hours or any other suitable unit. Water usage can be measured in liters or another suitable unit of volume. Waste metrics can indicate waste generated to generate and/or provide a product and/or service. Waste metrics may be delineated in any suitable unit. One example waste metric may describe a volume of waste material generated, for example, such as a volume of landfill space used. Other example resources that may be tracked are company assets including the collected environmental footprint for the creation and maintenance of the assets as well as for the consumption of the asset (e.g., runtime for a machine). In some examples, environmental metrics may be tracked at a higher-level of granular ready. For example, water usage may be tracked based on water type (e.g., drink, green, gray, waste, etc.). Also, for example, electricity usage may be tracked based on the source of the electricity (e.g., solar, wind, coal, natural gas, etc.).

Various examples described herein are directed to improving the operation of a DBMS by providing a technical arrangement for incorporating environmental metrics into a database arrangement for financial accounting. For example, a general ledger may be represented in a financial accounting DBMS application by a table or tables. Entries into the general ledger may correspond to various operations associated with the provision of goods and/or services. Examples of operations that may be described by entries into the general ledger include the sale of an item, the retrieval of an item from stock, the performance of a manufacturing operation on the item, and/or the like.

Entries in the general ledger may be described by a cost, where the cost indicates a monetary or nonmonetary item describing a transaction such as, for example, an asset, a liability, a revenue, and expense, and/or the like. For example, when the general ledger is implemented in one or more tables, one or more columns of the one or more tables may store the entry relating to cost or price. The cost or price may be represented by a currency value and may indicate a cost or price or the operation corresponding to the entry. In some examples, cost or price associated with a general ledger entry may be a number field that may take a value of zero. In some examples, the number field including the cost or price associated with the general ledger entry may be a field type associated with financial values delineated in currency. In some examples, the number field may be distinct from other types of fields used to described physical units such as units of measure.

In various examples, the DBMS may be implemented to include an environmental ledger integrated with the general ledger. The environmental ledger may comprise entries corresponding to operations described at the general ledger, but may also include one or more fields describing environmental metric values associated with the operations. In some examples, the environmental metric entries at the environmental ledger may be number fields, similar to fields used to store indications of currency associated with the cost or price of a general ledger entry.

The environmental ledger may be integrated with the general ledger. In some examples, the environmental ledger may be implemented using the same table or tables that implement the general ledger. For example, the environmental ledger may be implemented by adding an additional column or columns to the table or tables implementing the general ledger. The added column or columns may correspond to environmental metrics. Also, in some examples, the environmental ledger may be implemented at a table or tables separate from the table or tables corresponding to the general ledger. Columns at the table or tables implementing the environmental ledger may correspond to environmental metrics, as described herein. The table or tables implementing the environmental ledger, however, may be integrated with the table or tables implementing the general ledger, for example, using one or more views or other suitable constructs.

In some examples, the environmental ledger and the general ledger may be kept separate. Environmental metrics may be stored in the environmental ledger while financial values are stored in the general ledger. Environmental metrics at the environmental ledger may be referenced to a corresponding general ledger posting. In another example, environmental ledger and general ledger data may be stored in a common ledger. In various arrangements, the environmental metric may be associated with a corresponding financial figure. In this way, the environmental metric may be associated with the same root cause as a corresponding entry or entries in the general ledger. This may facilitate the triggering of reports, actions, and/or the like based on the underlying operation that is the subject of the financial entry to the general ledger and the environmental metric entry to the environmental ledger.

Also, in some examples, some emissions or other environment-impacting actions may not be linked to or directly linkable to particular business transactions described at the general ledger. For example, a chemical reaction occurring during manufacture of a product may emit greenhouse gases, but the chemical reaction itself may not be posted to the general ledger because there is no associated payment. The environmental ledger may include postings related to such activities that have an environmental impact, but are not directly linkable to a particular business transaction at the general ledger.

In various implementations, environmental metric fields at the environmental ledger may be treated in a manner similar to cost or price entries at the general ledger. For example, reports, aggregations, and other actions supported by the DBMS on the basis of cost may also be supported on the basis of one or more environmental metrics. In some example implementations, the DBMS may be arranged to post and report financial and environmental metrics in parallel at an account level. For example, each component of a product and/or service may be tracked for its financial impact as well as for its impact on the various environmental metrics. In this way, environmental metrics and financial metrics may be tracked, described, reconciled, incorporated into reports, and/or otherwise managed according to a common framework. For example, environmental metrics may be used, in conjunction with the environmental ledger and the general ledger, to financially reconcile or consolidate business quantities between legal units belonging to a group company to indicate environmental metric values for the various legal units. Also, environmental metrics may be incorporated into normal accounting-related activities, such as closing, generating of a balance sheet, generating of profit and loss (P&L), and/or the like. In some examples, the environmental metrics may be used in conjunction with management reporting, analysis, and decision making including an environmental focus into the traditional rationale.

For example, the DBMS may provide drill down capabilities crossing both environmental and financial dimensions of the data. In this way, environmental metrics may be expressed in terms of a single line item (e.g., describing a single operation) and/or an aggregate across multiple operations such as, for example, a set of operations representing a good or service, a set of operations aggregated over multiple business units, and/or the like.

In some examples, the DBMS may be arranged to store quality data associated with various environmental metrics. For example, environmental metrics may be based on data of varying quality. This may be different than cost data, which can often be known. In this way, environmental metrics may aggregate across components of goods and/or services while also aggregating the quality data. This may provide quality data when environmental metrics for various components are aggregate across products, services, groups of related entities, and/or the like.

In some examples, the inclusion of environmental metric fields in an environmental ledger associated with a general ledger facilitates the incorporation of the environmental metrics into the processing of the DBMS in a way that facilitates various objectives, such as, for example, compliance with environmental reporting. For example, the environmental ledger may be kept according to generally accepted bookkeeping standards such as, for example, Generally Accepted Accounting Principles (GAAP) in the United States, Grundsätze zur ordnungsmäβigen Führung und Aufbewahrung von Büchern, Aufzeichnungen und Unterlagen in elektronischer Form sowie zum Datenzugriff (GoBD) in Germany, and/or the like.

Utilizing existing DBMSs and ERP applications to track and determine environmental metrics, however, may present certain challenges. For example, environmental metrics may be relevant to a large portion of the transactions of an enterprise. Also, it may be desirable to track environmental metrics in an auditable manner. Accordingly, in some examples, environmental metric tracking may be incorporated into ERP applications and DBMSs that are otherwise arranged to support financial accounting.

Consider an example ERP application and DBMS arranged to utilize a universal journal table to manage financial accounts. In some examples, support for environmental metrics may be added by adding additional columns to the universal journal table. The additional columns may include environmental metric data associated with different transactions posted to the universal journal table such as, for example, various carbon footprint related matrices, resource use metrics, and/or the like.

Although an ERP application and DBMS arranged to use a universal journal table may support a large number of universal journal table columns, handling environmental metrics by adding columns to an existing universal journal table may generate challenges. For example, different enterprises may track different environmental metrics, for example, based on jurisdiction, industry, and/or the like. Accordingly, a practical accounting ERP application with support for the range of environmental metrics relevant to customer enterprises may utilize a very large number of additional universal journal table columns.

Also, environmental metric tracking may not be static. Regulations and best practices for tracking environmental metrics may change. If environmental metric data is incorporated into additional columns of the universal journal table, accounting for changes in environmental metrics may involve resource-costly modifications to universal journal table entries.

Various examples address these and other challenges by introducing a component breakdown table. The component breakdown table may be managed by the DBMS and may act as an extension of the universal journal table. For example, the universal journal table may be modified to include a key column that may store a key that references records at the component breakdown table. Entries at the universal journal table may comprise a key pointing to a corresponding entry or entries at the component breakdown table. Entries at the component breakdown table may store environmental metric data relating to transactions described by entries at the universal journal table. In some examples, entries at the component breakdown table may also store other information about the universal journal table transactions such as, for example, costs and/or the like. When it is desirable to respond to queries requesting data about environmental metrics, the DBMS may be arranged to generate one or more join operations that are created from the universal journal table and the component breakdown table.

In some examples, a hub application and environmental metric ledger may be used. The hub application and environmental metric ledger may be separate from the ERP application and, in some examples, may also utilize a DBMS different than the DBMS implementing the universal journal table and component breakdown table. The hub application and environmental metric ledger may be arranged to track environmental metrics that are not tied directly to a single transaction posted to the universal journal table. For example, the hub application may be arranged to access a set of transaction entries from the universal journal table. The hub application may determine an environmental metric that is related to multiple transaction entries accessed from the universal journal table. Such an environmental metric may be recorded to an environmental ledger entry that references the corresponding universal journal table entries. Also, in some examples, the hub application may determine an aggregate environmental metric that is aggregated over a number of universal journal table entries. Such an aggregate environmental metric may also be written to an environmental ledger entry. Further, in some examples, an environmental metric may not be tied to any particular universal journal entry. Data describing such environmental metrics may also be described in entries to the environmental ledger.

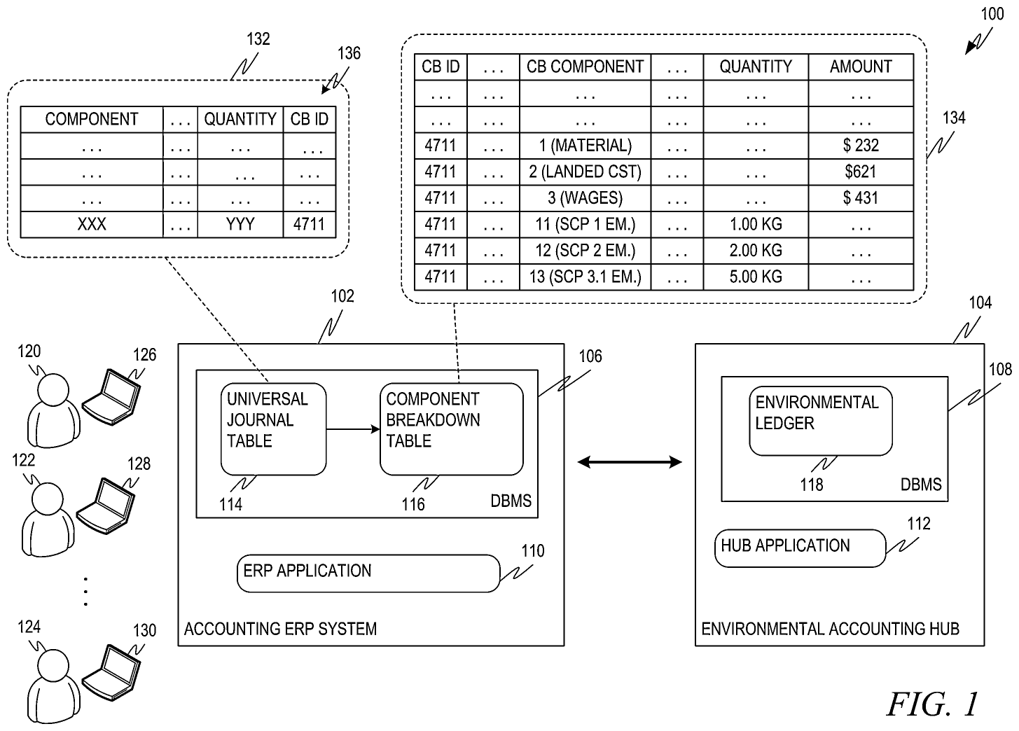

FIG. 1 is a diagram showing one example of an environment 100 comprising an accounting ERP system 102 and an environmental accounting hub system 104. The accounting ERP system 102 and environmental accounting hub system 104 may be arranged to utilize DBMSs 106, 108 to implement environmental metric management utilizing a universal journal table 114, a component breakdown table 116, and an environmental ledger 118.

The accounting ERP system 102 and environmental accounting hub system 104 may be respective computing systems. The accounting ERP system 102 and environmental accounting hub system 104 may be implemented in an on-premise environment and/or in a cloud environment. In an on-premise environment, an enterprise utilizing an accounting ERP application 110, DBMS 106, hub application 112, and DBMS 108 may maintain the accounting ERP system 102 and environmental accounting hub system 104 as one or more on-premise computing system. The accounting ERP application 110, DBMS 106, hub application 112, and DBMS 108 may be executed at the on-premise computing system.

In a cloud environment, the accounting ERP system 102 and environmental accounting hub system 104 are implemented by one or more servers and/or other computing devices maintained by a cloud provider and accessible remotely. In a private cloud environment, the enterprise using the accounting ERP system 102 and environmental accounting hub system 104 may provide applications, implement storage, and/or the like to implement the accounting ERP application 110, DBMS 106, hub application 112, and DBMS 108. In a public cloud environment, a cloud provider may maintain the accounting ERP system 102 and environmental accounting hub system 104 and provide a number of tenancies. The cloud provider may provide and maintain executables to implement the accounting ERP application 110, DBMS 106, hub application 112, and DBMS 108. An enterprise may purchase a tenancy to permit users associated with that enterprise to access the ERP system 102 and environmental accounting hub system 104 to use the accounting ERP application 110, DBMS 106, hub application 112, and DBMS 108.

Users 120, 122, 124 may access the ERP system 102 and environmental accounting hub system 104 to interact with the accounting ERP application 110, DBMS 106, hub application 112, and DBMS 108. In some examples, users 120, 122, 124 may utilize user computing devices 126, 128, 130 to communicate with the ERP system 102 and environmental accounting hub system 104. User computing devices 126, 128, 130 may be and/or include various different types of computing devices such as, for example, desktop computers, laptop computers, tablet computers, mobile computing devices, and/or the like. It will be appreciated that in some non-premise applications, a user may access the ERP system 102 and environmental accounting hub system 104 directly via input/output components of the ERP system 102 and environmental accounting hub system 104 such as, for example, a keyboard and/or a monitor.

FIG. 1 also shows a breakout windows 132, 134 illustrating example implementations of the universal journal table 114 and component breakdown table 116. In this example, each row of the universal journal table comprises a universal journal table entry. Each entry may correspond to a transaction entered into by an enterprise implementing the environment 100. For example, a transaction may include the acquisition or disposition of a component, the acquisition or disposition of a service, and/or the like. The columns of the universal journal table 114 may correspond to different data associated with different types of transactions. In this example, the universal journal table example shown at breakout window 132 comprises a component breakdown ID column 136. For example, entries at the universal journal table 114 may comprise component breakdown keys referencing a corresponding entry or entries at the component breakdown table 116.

In this example, the entry corresponding to a component XXX is associated with a component breakdown ID 4711. The component breakdown ID value for 711 may also be referred to as a vector. Referring now to the example of the component breakdown table 116, the component breakdown ID 4711 may be associated with additional information about the transaction represented by the universal journal table entry. In this example, there are three environmental metrics associated with the transaction, as indicated By Scope 1 Carbon Emissions, Scope 2 Carbon Emissions, and Scope 3.1 Carbon Emissions. Accordingly, in this example, there are three component table entries corresponding to environmental metrics associated with the indicated transaction entry at the universal journal table 114.

In some examples, the component breakdown table 116 may include additional information about the corresponding transaction entry at the universal journal table 114. In this example, additional entries indicate material costs, landed costs, and wage costs associated with the transaction.

In some examples, a single entry or entries at the component breakdown table may correspond to more than one transaction entry at the universal journal table 114. For example, similar transactions may utilize transaction entries at the universal journal table 114 having the same component breakdown ID. In this way, storage use may be reduced. For example, storing the cost, environmental metric, and other component data at the component breakdown table 116 as additional columns in the universal journal table 114 may involve duplicate data storage and/or other more complex and resource-intensive storage optimization techniques.

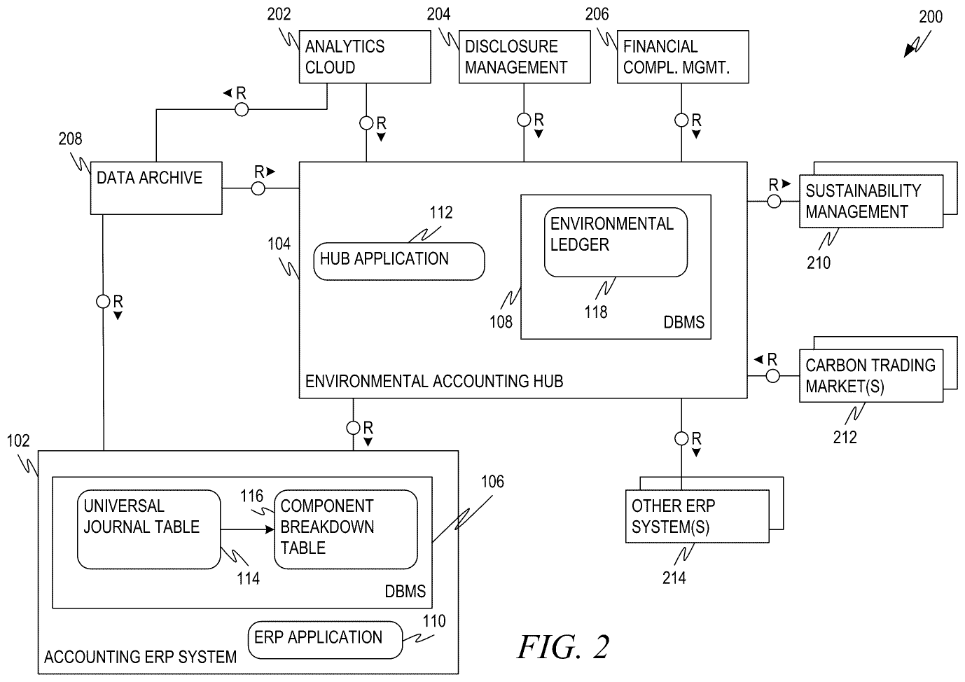

FIG. 2 is a diagram showing one example of an environment 200 illustrating the accounting ERP system 102 and environmental accounting hub system 104 in conjunction with additional components. The input additional components include an analytics cloud system 202, a disclosure management system 204, a financial compliance management system 206, a data archive system 208, a sustainability management system 210, a carbon trading market system 212, and other ERP systems 214. The various other systems in communication with the environmental accounting hub system 104 and accounting ERP system 102 may provide environmental metric data describing environmental metrics associated with various transactions posted as entries to the universal journal table 114.

The analytics cloud system 202 may, in some examples, provide a central location for storing data regarding environmental metric such as, for example, greenhouse gas emissions. In some examples, the analytics cloud system 202 may provide data storage to the environmental accounting hub system 104.

The disclosure management system 204 may provide data describing current applicable regulations regarding the tracking and or disclosure of environmental metrics. The disclosure management system 204, such as SAP Disclosure Management available from SAP SE of Waldorf Germany, may be configured to provide environmental disclosure data to one or more regulatory agency systems.

The financial compliance management system 206 may provide data describing applicable relations regarding the tracking and reporting of financial metrics including, for example, environmental metrics related to the financial metrics.

The sustainability management system or systems 210 may provide data regarding environmental metrics. For example, the sustainability management system or systems may provide data describing environmental metrics associated with different transactions including, for example, different manufacturing transactions, different shipping transactions, and/or the like. The sustainability management system 210 may be a software and/or hardware system configured to provide reports and/or user interfaces (UIs) describing one or more of the environmental metrics. A cloud analytics application, such as the SAP analytics cloud available from SAP SE of Waldorf Germany, may be utilized, for example, to calculate one or more of the environmental metrics and/or to provide data for calculating one or more of the environmental metrics.

Carbon trading market systems 212 may provide access to markets for carbon credits or other financial metric credits. For example, the hub application 112 may be configured to sell and or purchase carbon or other environmental metric credits in communication with the carbon trading market systems 212.

In some examples, the other ERP systems 214 may implement other ERP applications that may be in communication with the hub application 112. Examples of other ERP systems 214 that may be in communication with the hub application 112 include, for example, a human resources ERP system for providing data regarding commuting habits of employees, a manufacturing planning system for providing data regarding various different machines and other equipment used in manufacturing, and/or the like. The data archive system 208 may store, and provide to the hub application 112, information about various different transactions such as, for example, data describing different products and/or services and relating financial transactions to corresponding environmental metrics.

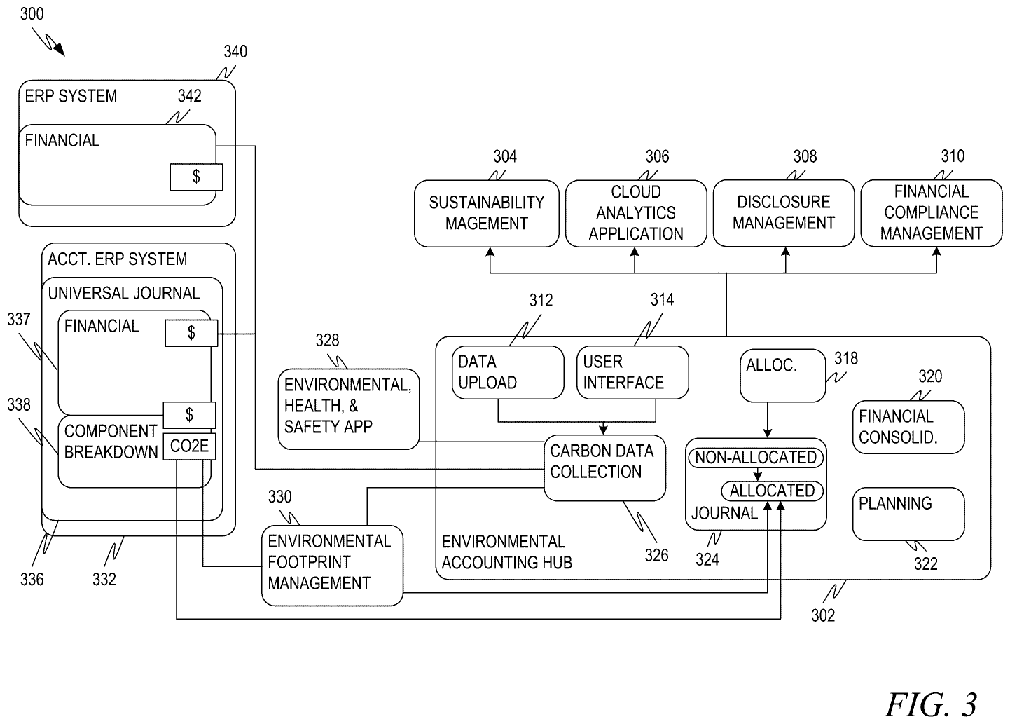

FIG. 3 is a diagram showing one example environment 300 comprising an accounting ERP system 332 and an environmental accounting hub system 302. The accounting ERP system 332 and environmental accounting hub system 302 may be implemented in a manner similar to that described herein with respect to the accounting ERP system 102 and environmental accounting hub system 104.

The accounting ERP system 332 and environmental accounting hub system 302 may, in some examples, utilize a DBMS that is or includes the S/4 HANA system available from SAP SE of Walldorf, Germany, although other DBMSs may be used in some examples. The accounting ERP system 332 comprises a universal journal table 336. The universal journal table 336 comprises financial entries 337. Financial entries 337 may include fields describing various operations including a cost field describing the operations, as described herein. The universal journal table 336 may also comprise a universal component breakdown table 338. The universal component breakdown table 338 may store component breakdown entries, for example, as described herein. In some examples, the accounting ERP system 332 may include one or more units of executable code configured to act on the financial entries 337 (in conjunction with the environmental accounting hub system 302) to generate various reports an aggregate data across different operations, and/or business units, as described herein.

FIG. 3 also includes the environmental accounting hub system 302. The environmental accounting hub system 302, in some examples, maintains an environmental ledger 324. The environmental ledger 324 may comprise entries similar to the financial entries 337, but relating to environmental metrics. For example, the environmental ledger 324 may include one or more fields indicating one or more environmental metrics that may correspond to the operations described by the financial entries 337 in a manner similar to the cost of the operations, as described herein.

In some examples, the universal journal table 334, including the financial entries 337 and the environmental accounting hub system 302, is implemented in a common database table or set of database tables and/or at different DBMSs. In some examples, the universal journal table 334, including the environmental accounting hub system 302, is implemented utilizing an ACDOCA table used in some examples of the HANA and S/4 HANA systems. A universal journal table can include columns or fields for multiple different kinds of accounting journal entries, often leading to a table with a large number of columns. For example, the ACDOCA table provided by the HANA and S/4 HANA database systems may include several hundred columns. The large number of columns in the universal journal table may allow multiple different types of accounting journal entries to be included as table records in the same table.

The universal journal table 114 may also include one or more extension ledgers, also referred to as appendix ledgers. An extension ledger is created as a layer on top of the universal journal table. The extension ledger references a subset of the journal entries of the universal journal table. For example, the component breakdown table 338 may be an extension ledger of the universal journal table 336. Use of the universal journal table 336 with extension ledgers can provide a technical advantage by more efficiently using memory. For example, a single universal journal table with one or more extension ledgers can be used to maintain multiple ledgers without storing duplicate journal entries at different tables.

Database systems utilizing a universal journal table (e.g., with one or more extension ledgers) may also be optimized to quickly and efficiently execute queries at large tables, such as a universal journal table. For example, the HANA and S/4 HANA systems are in-memory DBMSs in which the column stores for tables, such as a universal journal table, are stored in memory, such as a RAM, in addition to or instead of being stored at a disk storage mechanism. The optimizations of an in-memory DBMS may allow for the quick and efficient execution of queries against large tables, such as a universal journal table.

The environmental accounting hub system 302 may comprise an environmental ledger 324, where the environmental ledger 324 comprises various environmental metrics describing transactions from the universal journal table 336 and/or other transactions. In some examples, the environmental accounting hub system 302 may also comprise a data collection module 326. The data collection module 326 may be arranged to communicate with various external systems to obtain data that may be incorporated into entries at the environmental ledger 324.

The data collection module 326, for example, may communicate with a data upload module 312. The data upload module 312 may be arranged to receive environmental metric data from files such as, for example, one or more spreadsheets. The data collection module 326 may also communicate with a UI 314. The UI 314 may be provided to an administrative or other suitable user, such as users 120, 122, 124, via a user computing device, such as user computing device 126, 128, 130. The user may, through the UI 314, provide data describing one or more environmental metrics. The data collection module 326 may also be in communication with an environmental health and safety (EHS) application 328, such as the EHS application available from SAP SE of Waldorf, Germany. The EHS application 328 may provide data used to generate one or more environmental metrics stored at the environmental ledger 324.

The data collection module 326 and/or other components of the environmental accounting hub system 302 may also be in communication with other components including a sustainability management system 304, a cloud analytics application 306, a disclosure management system 308, and/or a financial compliance management application 310, which may operate in a manner similar to that described herein with respect to the sustainability management system 210, the analytics cloud system 202, the disclosure management system 204, and the financial compliance management system 206. FIG. 3 shows other examples of how the data upload module 312 (or other component(s) of the accounting ERP system 332) can connect to various other components to obtain data to be directly or indirectly included in one or more environmental journal entries.

The environmental accounting hub system 302 may also comprise an allocation module 318. The allocation module 318 may comprise one or more software and/or hardware components arranged to allocate environmental metric values to various operations described by journal entries at the environmental ledger 324. For example, environmental metric values may be manually allocated to the entries and/or automatically allocated, for example, based on rules.

In some examples, the accounting ERP system 332 may be in communication with one or more enterprise resource planning systems 340, which may be similar to the other ERP systems, such as the ERP system 214 of FIG. 2. An example enterprise resource planning system 340 is a financial enterprise resource planning system 342. Various enterprise resource planning systems 340, including financial enterprise resource planning system 342, may provide data describing operations, costs associated with operations, and/or environmental data comprising and/or used to generate environmental metrics.

The environmental accounting hub system 302 may also comprise a financial consolidation module 320 and a planning module 322. The financial consolidation module 320 may be configured to consolidate entries at the environmental accounting hub system 302 with corresponding entries at the universal journal table 334. The planning module 322 may be configured to generate projections for environmental metrics described by entries at the environmental accounting hub system 302.

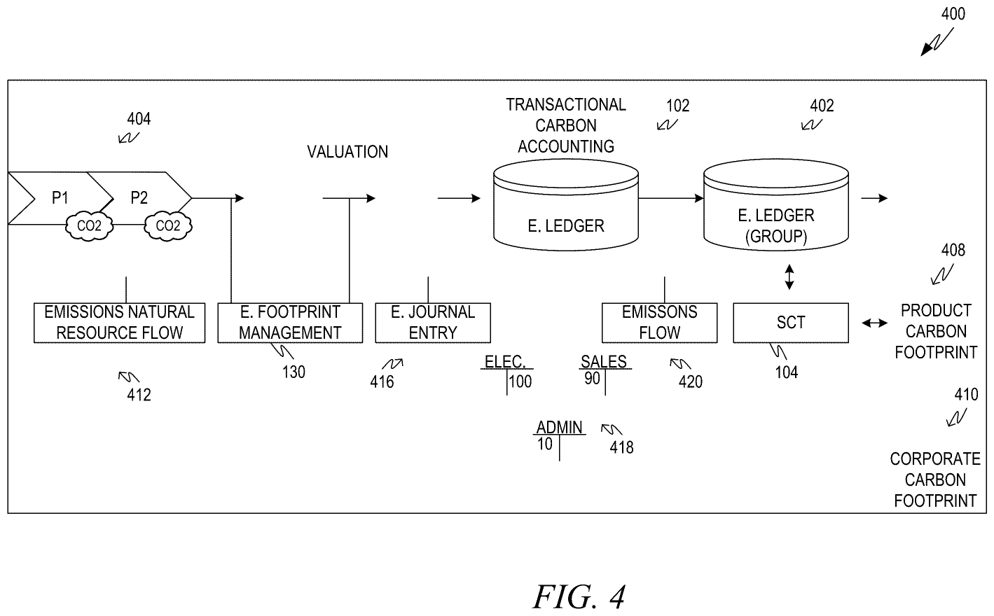

FIG. 4 is a workflow diagram showing one example of a process flow 400 that may be executed in the environment 300 of FIG. 3. The process flow 400 includes a set of process operations 404. The set of process operations 404 may comprise one or more transactions that are the subject of respective entries in the universal journal table 336 and/or environmental accounting hub system 302. In some examples, the various process operations 404 may be the result of operations that produce greenhouse gases and/or generate another environmental result that can be described by an environmental metric. The process operations 404 may be described by environmental data 412, which may include data describing emissions, such as greenhouse gases emissions or other emissions, as well as resources consumed.

In some examples, the environmental footprint management system 330 may receive the environmental data 412 and generate an environmental journal entry 416. In some examples, the environmental journal entry 416 was generated by the financial application for managing the environmental journals (e.g., the ERP application 110). The environmental journal entry 416 may include values for one or more environmental metrics associated with one or more of the process operations 404. In some examples, the environmental journal entry 416 may comprise data that is used to generate values for one or more environmental metrics associated with the process operations 404. In some examples, the environmental journal entry 416 may comprise multiple environmental metrics 418, for example, associated with different aspects of the process operations 404. In the example of FIG. 4, the environmental journal entry 416 describes a greenhouse gas amount associated with electricity for performing the process operations 404, a greenhouse gas amount associated with administration of the process operations 404, and a greenhouse gas amount associated with the cost of sales for the process operations 404.

The environmental journal entry 416 may be provided to the environmental accounting hub system 302, where it may be stored. The environmental journal entry 416 may be correlated to a corresponding entry at a general ledger kept by the universal journal table 334. In some examples, the environmental journal entry 416 may comprise values at one or more columns of a single general ledger entry at the universal journal table 334. In other examples, the environmental journal entry 416 may be related to one or more corresponding entries at the general ledger using a view and/or other construct.

An emissions flow module 420 may utilize one or more environmental journal entries, such as the environmental journal entry 416 to generate a group environmental accounting ledger 402. In some examples, the sustainability management system 304 and/or the universal component breakdown table 338 may be used to generate and/or access the group environmental accounting ledger 402. The group environmental accounting ledger 402 may facilitate universal component breakdown. This may include, for example, attributing environmental metrics across different products, business units, and/or the like, thereby generating aggregate environmental metrics.

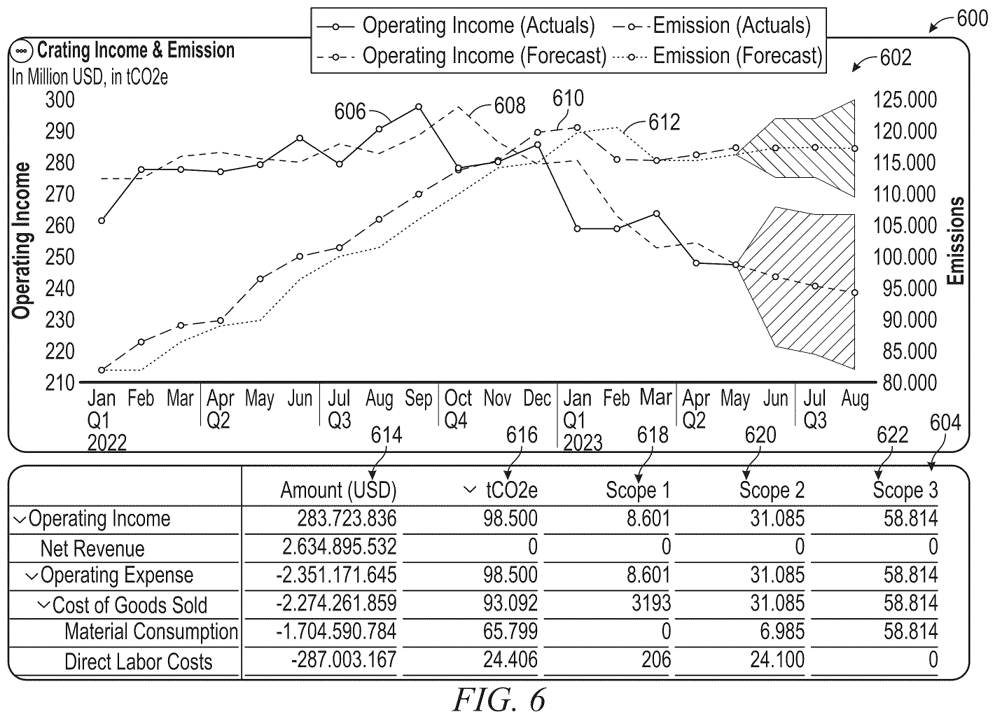

Example aggregate environmental metrics include a product carbon footprint 408 and a corporate carbon footprint 410. The product carbon footprint 408 may be generated by aggregating carbon footprint metrics across various process operations 404 for manufacturing, stocking, and/or other component operations for selling a product. A corporate carbon footprint 410 may describe greenhouse gas emissions over a business entity unit. The generated aggregate environmental metrics may be determined with financial metrics to describe parallel products, business units, and/or the like, as illustrated in FIG. 6. In this way, the accounting ERP system 332 may enable one-to-one comparison of environmental, financial, and other similar metrics.

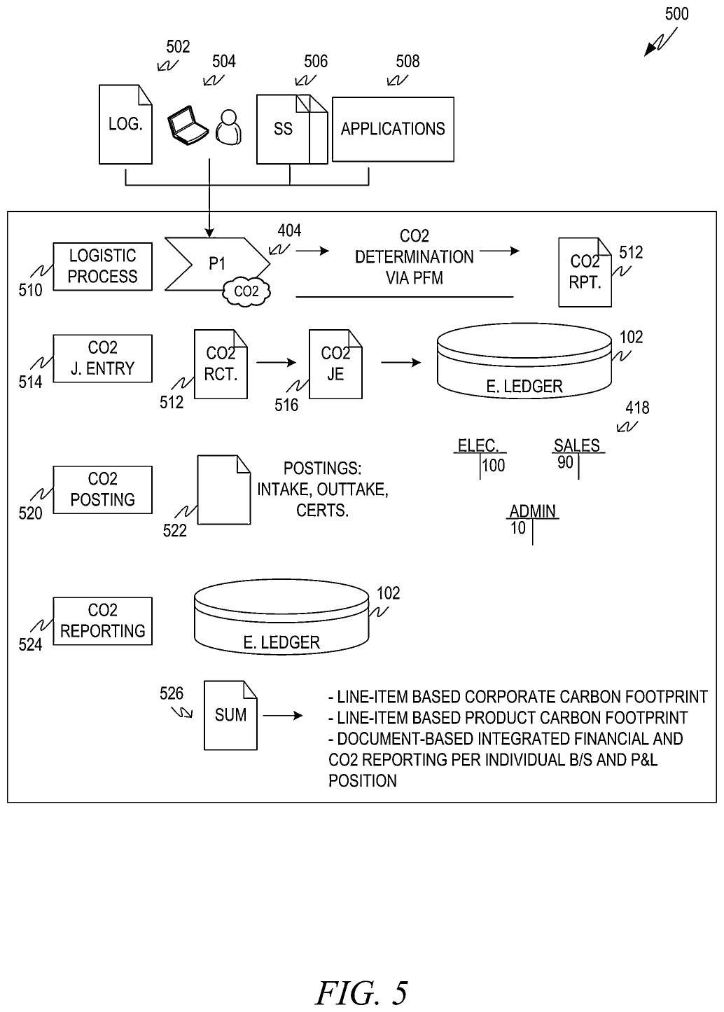

FIG. 5 is a workflow diagram showing another example of a process flow 500 that may be executed in the environment 300. The process flow 500 describes data describing one or more process operations 404, which may be similar to the process operations 404 of FIG. 4. Process flow 500 is described in the context of a greenhouse gas emission or greenhouse gas footprint environmental metric. It will be appreciated that the process flow 500 may be executed with respect to environmental data describing other environmental metrics in addition to or instead of greenhouse gas-related metrics.

The process flow 500 comprises a logistic process operation 510, an environmental journal entry operation 514, an environmental posting operation 520, and an environmental reporting operation 524. The logistic process operation 510 may comprise one or more process operations 404, which may be similar to the process operations 404 of FIG. 4. Data describing the process operations 404 may be provided in various example formats such as, for example, a logistics document 502, user input 504, spreadsheet data 506, and output data 508. The logistics document 502 may describe the one or more process operations 404 and may be generated, for example, in an automated manner in response to, for example, a triggering of the process operations 404, a completion of the process operations 404, and/or the like. User input 504 may be provided by a user, for example, via a sustainability management system 304 or other suitable interface. Spreadsheet data 506 may be provided in a spreadsheet format such as, for example, a Microsoft Excel format, a Google sheets format, and/or the like. Output data 508 may be generated by a system or process, such as, for example, an enterprise resource planning system, such as the enterprise resource planning system 340.

The logistics process operation 510 may utilize data describing the process operations 404 to generate an environmental receipt 512. The environmental receipt 512 may comprise values for one or more environmental metrics describing the process operations 404. The logistic process operation 510 may be performed, for example, by an environmental footprint management system 330.

At the environmental journal entry operation 514, the environmental receipt 512 may be converted to an environmental journal entry 336 to be stored at the environmental accounting hub system 302. The environmental journal entry operation 514 may be performed, for example, by the environmental accounting hub system 302 and/or its supporting applications.

At environmental posting operation 520, the environmental journal entry 516 at the environmental accounting hub system 302 may be used to generate various postings, intakes, outtakes, certificates, and/or other derivative data 522 including or based on environmental metrics 418 associated with the process operations 404 and described by the environmental journal entry 516.

The environmental reporting operation 524 may include generating various environmental outputs 526. This may include, for example, universal component breakdown performed by the universal component breakdown table 338 to attribute various environmental metrics 418 across different products, components of products, business units, and/or time periods to generate the environmental outputs 526. In some examples, the environmental reporting operation 524 may be performed by the universal component breakdown table 338.

FIG. 6 is a diagram of an output screen 600 showing example environmental outputs, such as the environmental outputs 526. The output screen 600 may be displayed to a user, for example, as part of a report generated by the accounting ERP system 332.

The output screen 600 includes a graphical output section 602 and a numerical output section 604. The graphical output section 602 comprises plots 606, 608, 610, and 612. Plot 610 describes an actual operating income, for example, for a business entity. Plot 612 describes a forecast operating income for the business entity. Plot 606 describes an environmental metric, in this example a greenhouse gas emission level (e.g., a carbon dioxide equivalent emission level measured in metric tons), for business entity. Plot 608 describes a forecast environmental metric for the business entity.

The arrangement described herein, including the environmental accounting hub system 302 and integration between the environmental accounting hub system 302 and the general ledger, may facilitate the generation of environmental output data similar to what is shown at the graphical output section 602. For example, in the graphical output section 602, data is aggregate with respect to price/cost (which relates to operating income) and carbon dioxide equivalent emissions (which is an environmental metric). Utilizing the environmental accounting hub system 302, as described herein, may facilitate the generation of output data based on financial accounting metrics, such as operating income, and environmental metrics, such carbon dioxide equivalent emissions, over the same time periods, business units, process operations, and/or the like. This may facilitate incorporation of environmental metrics into the overall business planning process and management.

Another example of these advantages is given by the numerical output section 604. The numerical output section 604 includes a breakdown of the operating income metric plotted at the graphical output section 602 and broken down by subcomponents including net revenue, operating expense, cost of goods sold, material consumption, and direct labor costs.

Column 614 indicates a dollar amount for each subcomponent. Column 616 describes an associated environmental metric (e.g., carbon dioxide equivalent greenhouse gas emissions) for each subcomponent. Columns 618, 620, and 622 describe breakdowns of the environmental metrics shown at column 616 over various different scopes. Each scope may correspond to a different product, plant, process operation, and/or the like. In some examples, the scopes indicated at columns 618, 620, and 622 may relate to scopes that may be similarly described by financial metrics, such as operating income and/or the like. The use of the environmental accounting hub system 302, as described herein, may facilitate the generation of environmental metrics at the various scopes that may also be described by corresponding financial metrics.

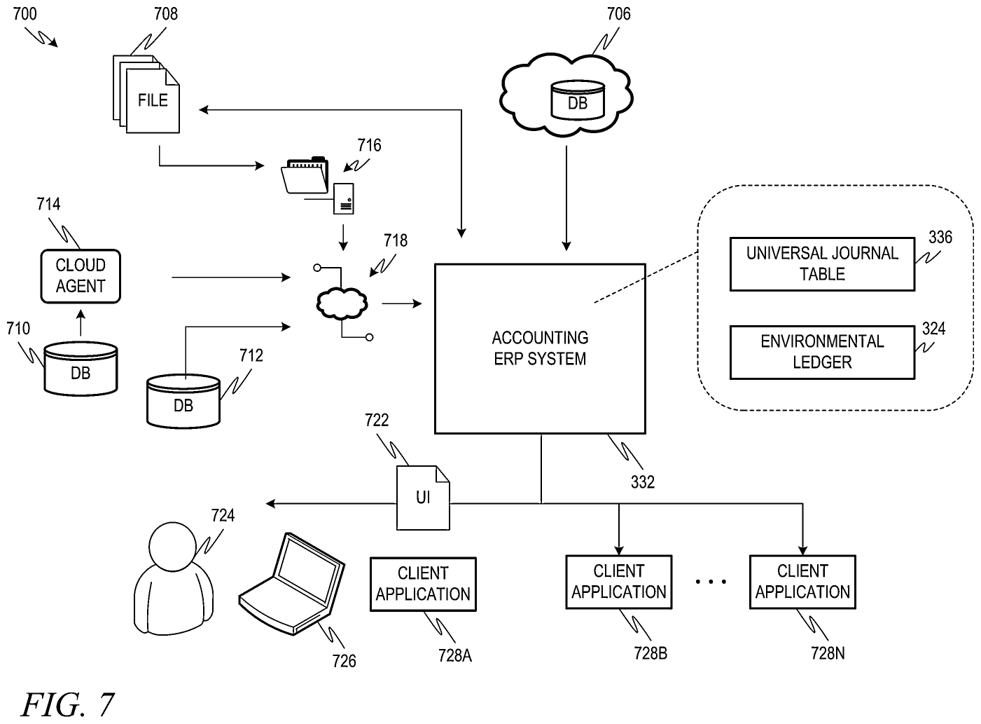

FIG. 7 is a diagram showing one example of an environment 700 for generating environmental metrics using distributed database systems. The environment 700 shows one example arrangement using the accounting ERP system 332 used to implement the environmental accounting hub system 302 described herein. The environment 700 includes an accounting ERP system 332. The accounting ERP system 332 can be implemented using any suitable computing device or set of computing devices. The DBMS may implement an environmental ledger 324 and an associated environmental accounting hub system 302, for example, as described herein. In some examples, the accounting ERP system 332 includes one or more servers located at a single geographic location or distributed across multiple geographic locations. The accounting ERP system 332, in some examples, is or includes a HANA or S/4 HANA system available from SAP SE of Walldorf, Germany.

The accounting ERP system 332 may be in communication with various other data sources via different types of connections. For example, the accounting ERP system 332 may be in communication with a cloud database system 706. The cloud database system 706 may be implemented using one or more computing devices, such as servers, at a single geographic location or distributed across multiple geographic locations. The accounting ERP system 332 can also be in communication with other types of data sources such as, for example, one or more files 708, one or more locally-implemented database systems 710, 712, etc. Files 708 may include spreadsheets, locally-stored databases, or any other suitable files.

The data sources 706, 708, 710, 712 can include various data such as, for example, environmental data describing one or more process operations, as described herein. For example, one or more of the data sources 706, 708, 710, 712 may be or be associated with an accounting system and may include one or more accounting system tables including quantity structure data describing the structure of a product. Such data may be used, for example, by the universal component breakdown table 338, as described herein.

Also, in some examples, one or more of the data sources 706, 708, 710, 712 may be environmental compliance database systems including environmental metric data including values for one or more environmental metrics and/or data used to generate values for environmental metrics. An example database system for environmental compliance is the EHS Management system available from SAP SE of Walldorf, Germany.

Different data sources 706, 708, 710, 712 may connect to the accounting ERP system 332 in different ways. For example, the cloud database system 706 may connect to the accounting ERP system 332 via a wide area network (WAN), such as the Internet. Files 708 may be connected to the accounting ERP system 332 directly via a communications network such at the Internet and/or via a local file server 716. In some examples, the accounting ERP system 332 is configured to access a universal resource locator (URL) associated with one or more files 708 including direct or indirect carbon footprint data via a WAN. In another example, the accounting ERP system 332 is configured to access a file server 716, where the file server 716 and the files 708 are stored at a common local area network (LAN). The accounting ERP system 332 connects to the file server 716 via a WAN and a cloud connector 718, such as the Cloud Platform Cloud Connector available from SAP SE of Walldorf, Germany. The file server 716, in turn, retrieves data from the files 708 via the LAN and provides it to the accounting ERP system 332 via the WAN.

FIG. 7 also shows two example ways that the accounting ERP system 332 can connect to database systems 710, 712 that are present on a LAN. In some examples, the accounting ERP system 332 connects to a database system 712 utilizing a cloud connector 718. For example, the cloud connector 718 is configured to communicate with the accounting ERP system 332 via a WAN and with the database system 712 via a LAN. The cloud connector 718 configures communication between the accounting ERP system 332 and the database system 712. In some examples, a cloud agent 714, such as the Analytics Cloud Agent available from SAP SE of Walldorf, Germany is positioned between a database system 710 and the cloud connector 718 to facilitate communications between the database system 710 and the accounting ERP system 332.

Results of the accounting ERP system 332 including, for example, environmental metrics for one or more products, can be provided to a user 724 via one or more client applications 728A, 728B, 728N. In the example of FIG. 7, the user 724 executes a client application 728A on a user computing device 726. The user computing device 726 may be or include any suitable computing device including, for example, a tablet computer, a mobile telephone, a laptop computer, etc. The client application 728A provides the user 724 with a UI 722 that includes various environmental metrics determined as described herein. In this way, the user 724 can access the DBMS 732 to receive environmental metrics generated with data from one or more of the data sources 706, 708, 710, 712 without the need to modify the data sources 706, 708, 710, 712 or directly access the data sources 706, 708, 710, 712.

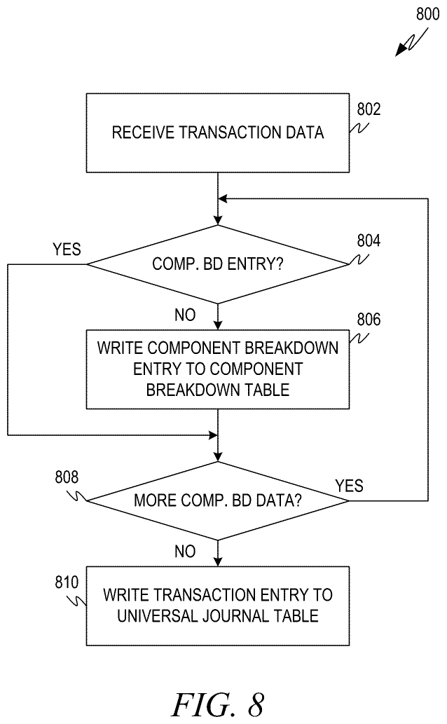

FIG. 8 is a flowchart showing one example of a process flow 800 that may be implemented by an accounting ERP application to post a transaction entry to a universal journal table. In some examples, the accounting ERP application may execute at an accounting ERP system, as described herein. At operation 802, the accounting ERP application may receive transaction data. Transaction data may describe a transaction entered into by the enterprise implementing the accounting ERP application. For example, the transaction may describe the acquisition of material, the acquisition of a service, the selling of a material, the selling of a service, and/or the like. In some examples, the transaction data may also include component breakdown data. Component breakdown data may include data describing the transaction that is not to be stored at the universal journal table. For example, the component breakdown data may include constituent costs for the transaction such as, for example, material cost, landed cost, wage cost, and/or the like. In some examples, the component breakdown data includes environmental metric data describing one or more environmental metrics associated with the transaction. In some examples, the ERP application is configured to prompt one or more other systems to receive some or all of the component breakdown data.

At operation 804, the accounting ERP application may determine if there is an existing component breakdown table entry corresponding to a first unit of component breakdown data, such as for example, a first environmental metric. If there is no component breakdown table entry corresponding to the first unit of component breakdown data then, the ERP application may write a component breakdown entry indicating the first unit of component breakdown data to the component breakdown table including a component breakdown key and then proceeded to operation 808. If there is a component breakdown table entry corresponding to the first unit of component breakdown data then, the ERP application may proceed to operation 808 without writing and additional component breakdown entry.

At operation 808, the accounting ERP application may determine if there are additional units of component breakdown data associated with the described transaction. If there are additional units of component breakdown data, then the accounting ERP application may return to operation 804 and determine if there is an existing component breakdown table entry associated with the next units of component breakdown data. If there is not, then the accounting ERP application may, at operation 806, write an additional component breakdown entry to the component breakdown table. If a previously-considered unit of component breakdown data is already the subject of a component breakdown table entry, then a new component breakdown table entry may utilize the same component breakdown key as the other entry. When there is no more component breakdown data associated with the transaction at operation 808, then the accounting ERP application may write a transaction entry to the universal journal table at operation 810. The transaction entry may include the component breakdown key, which may act as a factor pointing to the relevant entry or entries at the component breakdown table.

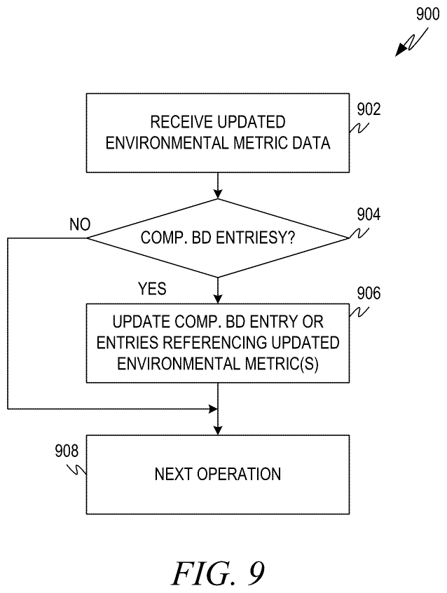

FIG. 9 is a flowchart showing one example of a process flow 900 that may be executed, for example, by an accounting ERP application or other component to update the component breakdown table. For example, component breakdown data stored at the component breakdown table may be subject to updates based on additional information, changes to previously known information, changes to environmental metric definitions and/or reporting requirements, and/or the like. As described with respect to FIG. 9, such changes may be implemented by making a change to a single entry or a limited number of entries at the component breakdown table instead of modifying every entry at the universal journal table referencing the modified unit of component breakdown data.

At operation 902, the accounting ERP application may receive updated environmental metric data. At operation 904, the accounting ERP application may determine if there are any component breakdown entries at the component breakdown table referencing an environmental metric modified by the updated environmental metric data. If there are no component breakdown entries at the component breakdown table referencing the updated environmental metric or metrics, then the accounting ERP application may move to its next operation at operation 908. If one or more environmental metrics referenced by the updated environmental metric data are the subject of one or more component breakdown entries at the component breakdown table, then the accounting ERP application may update the relevant component breakdown entries at the component breakdown table at operation 906.

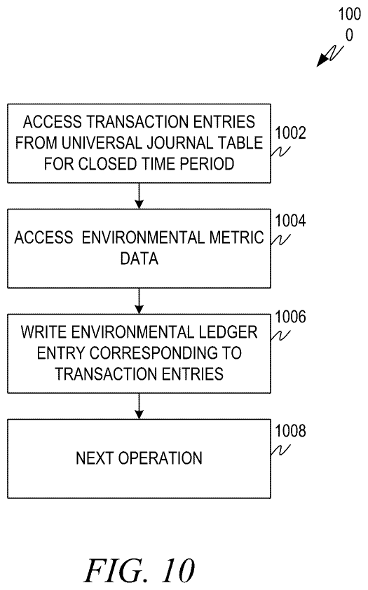

FIG. 10 is a flowchart showing one example of a process flow 1000 that may be executed by an environmental accounting hub system or hub application executing thereon. At operation 1002, the hub application may access transaction entries from the universal journal table for a closed time period, such as a closed accounting. A closed time period may be a period for which accounting functions have closed (e.g., for which all entries have been reconciled or otherwise assessed to be complete and accurate). At operation 1004, the hub application may access environmental metric data, for example, from an outside system. The environmental metric data may describe one or more environmental metrics that apply to a set of multiple transactions. At operation 1006, the hub application may write an environmental ledger entry corresponding to the accessed transaction entries. The environmental ledger entry may include a reference to the set of transaction entries from the universal journal table that are described by the environmental metric indicated by the environmental ledger entry. At operation 1008, the hub application may move to a next operation.

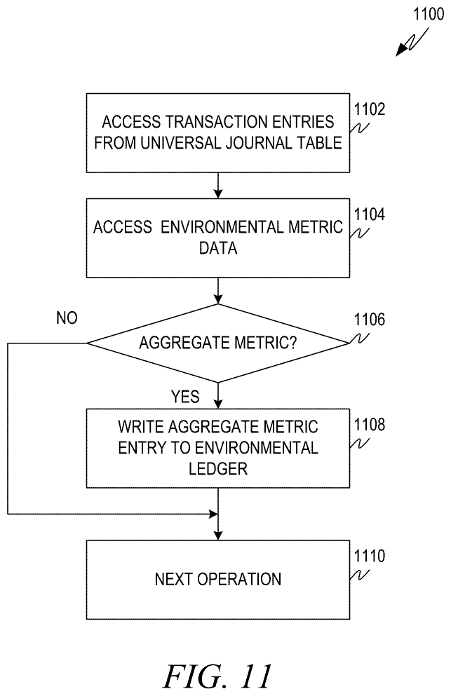

FIG. 11 is a flowchart showing another example of a process flow 1100 that may be executed by an environmental accounting hub system or hub application executing thereon. At operation 1102, the hub application may access transaction entries from the universal journal table. At operation 1104, the hub application may access environmental metric data, for example, from an outside system. At operation 1106, the hub application may determine if there is an aggregate environmental metric that applies to some or all of the transaction entries. An aggregate environmental metric may be an environmental metric that applies over a number of transactions, but may not apply to or be accounted for as an individual transaction level. Examples may include some forms of greenhouse gas emissions. If there is no aggregate metric, then the hub application may move to its next operation at operation 1110. If there is an aggregate environmental metric, then the hub application may, at operation 1108, write an additional entry to the environmental ledger indicating the aggregated environmental metric. In some examples, the additional entries of the environmental ledger may also reference the transaction entries from the universal journal table that are relevant to the environmental metric.

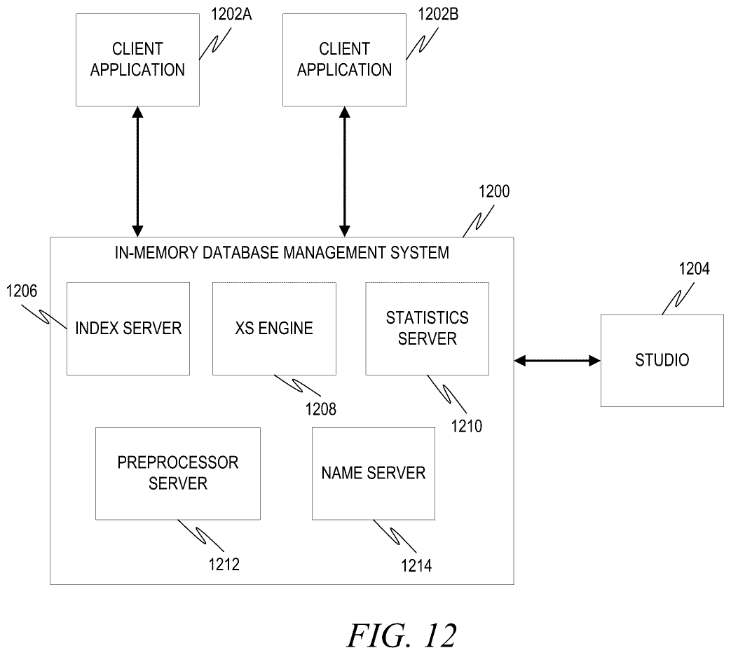

FIG. 12 is a diagram illustrating an example of an in-memory DBMS 1200. An in-memory database stores data primarily at main memory, such as a RAM. This is different than databases that primarily employ a disk storage mechanism. In some examples, the DBMS 1200 may be or include an example of the HANA system from SAP SE of Walldorf, Germany. Although various features of environmental metric integration are described herein in the context of an in-memory database, carbon footprint accounting and optimization may be generally performed at any suitable DBMS.

The in-memory DBMS 1200 can be used to implement various components described herein. In some examples, the in-memory DBMS 1200 can be optimized for financial accounting and may include a universal journal table, as described herein. In other examples, the in-memory DBMS 1200 can be optimized for storing environmental compliance data, as described herein. In some examples, the in-memory DBMS 1200 can be used to implement the web-based analytics system including, for example, internal storage thereof.

The in-memory DBMS 1200 may be coupled to one or more client applications 1202A, 1202B. Client applications 1202A, 1202B may perform operations to implement the general ledger and environmental ledger, as described herein. The client applications 1202A, 1202B may communicate with the in-memory DBMS 1200 through a number of different protocols, including Structured Query Language (SQL), Multidimensional Expressions (MDX), Hypertext Transfer Protocol (HTTP), Representational State Transfer (REST), and/or Hypertext Markup Language (HTML).

FIG. 12 also shows a studio 1204 that may be used to perform modeling by accessing the in-memory DBMS 1200. In some examples, the studio 1204 may allow complex analysis to be performed on data drawn not only from real time event data and windows, but also from stored database information. In some examples, carbon footprint data may be generated by the studio as described herein.

The in-memory DBMS 1200 may comprise a number of different components, including an index server 1206, an XS engine 1208, a statistics server 1210, a preprocessor server 1212, and a name server 1214. These components may operate on a single computing device or may be spread among multiple computing devices (e.g., separate servers).

The index server 1206 contains the actual data and the engines for processing the data. It may also coordinate and uses the other servers.

The XS engine 1208 allows clients to connect to the in-memory DBMS 1200 using web protocols, such as Hypertext Transfer Protocol (HTTP). Although the XS engine 1208 is illustrated as a component of the in-memory DBMS 1200, in some examples, the XS engine may be implemented as one or more Application Program Interfaces (APIs) and/or services positioned between the client applications 1202A, 1202B and the in-memory DBMS 1200. In some examples, the XS engine 1208 may handle client requests received in languages other than SQL such as, for example, MDX, HTTP, REST, HTML, and the like.

The statistics server 1210 collects information about status, performance, and resource consumption from all the other server components. The statistics server 1210 can be accessed from the studio 1204 to obtain the status of various alert monitors.

The preprocessor server 1212 is used for analyzing text data and extracting the information on which the text search capabilities are based.

The name server 1214 holds information about the database topology. This is used in a distributed system with instances of the database on different hosts. The name server 1214 knows where the components are running and which data is located on which server. In an example embodiment, a separate enqueue server may operate in the manner described above with respect to enqueue servers, specifically with regard to creating and managing light-weight enqueue sessions.

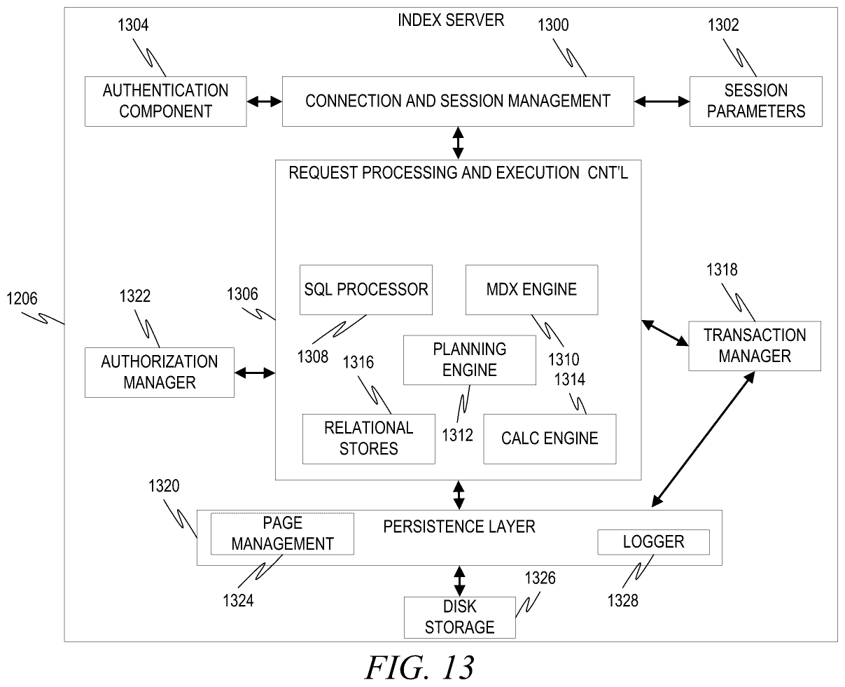

FIG. 13 is a diagram illustrating an example of the index server 1206. Specifically, the index server 1206 of FIG. 12 is depicted in more detail. The index server 1206 includes a connection and session management component 1300, which is responsible for creating and managing sessions and connections for the database clients (e.g. client applications 1202A, 1202B). Once a session is established, clients can communicate with the database system using SQL statements. For each session, a set of session parameters 1302 may be maintained, such as auto-commit, current transaction isolation level, etc. Users (e.g., system administrators, developers) may be authenticated by the database system itself (e.g., by logging in with log-in information such as a user name and password, using an authentication component 1304) or authentication can be delegated to an external authentication provider such as a Lightweight Directory Access Protocol (LDAP) directory.

Client requests, such as contract form requests, can be analyzed and executed by a set of components summarized as request processing and execution control 1306. An SQL processor 1308 checks the syntax and semantics of the client SQL statements and generates a logical execution plan.

MDX is a language for querying and manipulating multidimensional data stored in Online Analytical Processing (OLAP) cubes. As such, an MDX engine 1310 may be provided to allow for the parsing and executing of MDX commands. A planning engine 1312 allows applications to execute basic planning operations in the database layer. One such operation is to create a new version of a dataset as a copy of an existing dataset, while applying filters and transformations.

A calculation engine 1314 implements the various SQL script and planning operations. The calculation engine 1314 creates a logical execution plan for calculation models derived from SQL script, MDX, planning, and domain-specific models. This logical execution plan may include, for example, breaking up a model into operations that can be processed in parallel. The data is stored in relational stores 1316, which implement a relational database in main memory. Each SQL statement may be processed in the context of a transaction. New sessions are implicitly assigned to a new transaction. A transaction manager 1318 coordinates database transactions, controls transactional isolation, and keeps track of running and closed transactions. When a transaction is committed or rolled back, the transaction manager 1318 informs the involved engines about this event so they can execute needed actions. The transaction manager 1318 also cooperates with a persistence layer 1320 to achieve atomic and durable transactions.

An authorization manager 1322 is invoked by other database system components to check whether the user has the specified privileges to execute the requested operations. The database system allows for the granting of privileges to users or roles. A privilege grants the right to perform a specified operation on a specified object.

The persistence layer 1320 ensures that the database is restored to the most recent committed state after a restart and that transactions are either completely executed or completely undone. To achieve this goal in an efficient way, the persistence layer 1320 uses a combination of write-ahead logs, shadow paging, and save points. The persistence layer 1320 also offers a page management interface 1324 for writing and reading data to a separate disk storage 1326, and also contains a logger 1328 that manages the transaction log. Log entries can be written implicitly by the persistence layer 1320 when data is written via the persistence interface or explicitly by using a log interface.

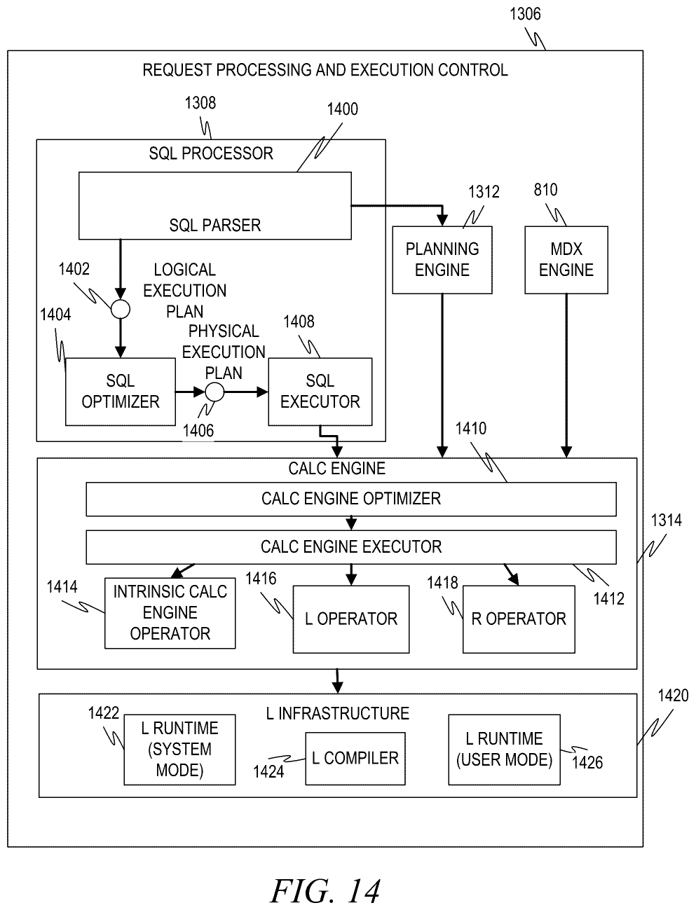

FIG. 14 is a diagram illustrating one example of the request processing and execution control 1306. This diagram depicts the request processing and execution control 1306 of FIG. 13 in more detail. The SQL processor 1308 contains an SQL parser 1400, which parses the SQL statement and generates a logical execution plan 1402, which it passes to an SQL optimizer 1404. The SQL optimizer 1404 optimizes the logical execution plan 1402 and converts it to a physical execution plan 1406, which it then passes to a SQL executor 1408. The calculation engine 1314 implements the various SQL script and planning operations, and includes a calc engine optimizer 1410, which optimizes the operations, and a calc engine executor 1412, which executes the operations, as well as an intrinsic calc engine operator 1414, an L operator 1416, and an R operator 1418.

An L infrastructure 1420 includes a number of components to aid in the running of L procedures, including an L-runtime (system mode) 1422, an L compiler 1424, and an L-runtime (User mode) 1426.

In view of the disclosure above, various examples are set forth below. It should be noted that one or more features of an example, taken in isolation or combination, should be considered within the disclosure of this application.

### EXAMPLES

Example 1 is a system for using a database management system to post a transaction, comprising: at least one processor programmed to perform operations comprising: executing an enterprise resource planning (ERP) application; receiving, by the ERP application, first transaction data, the first transaction data associated with a first transaction including acquisition of a first component of a first component type, the first transaction data describing an indicator of the first component, a cost of the first component of a first component type, and a first environmental metric associated with the first component; writing, by the ERP application, a first transaction entry to a universal journal table of the database management system, the first transaction entry comprising a description of the first transaction and a component breakdown key; and writing, by the ERP application, a first component breakdown entry to a component breakdown table of the database management system, the component breakdown entry comprising a first field indicating the component breakdown key, a second field indicating the first component, and a third field indicating the environmental metric associated with the first component.

In Example 2, the subject matter of Example 1 optionally includes operations further comprising: receiving second transaction data, the second transaction data associated with a second transaction including a second component of the first component type; and writing, to the universal journal table of the database management system, a second transaction entity comprising an indication of the second component and the component breakdown key.

In Example 3, the subject matter of any one or more of Examples 1-2 optionally includes operations further comprising: after writing the first component breakdown entry to the component breakdown table, receiving an updated first environmental metric associated with the first component; and updating the first component breakdown entry based on the updated first environmental metric.

In Example 4, the subject matter of any one or more of Examples 1-3 optionally includes operations further comprising: accessing, by a hub application, a set of transaction entries from the universal journal table, the set of transaction entries being for transactions from a closed time period, the set of transaction entries comprising the first transaction entry, the hub application being distinct from the ERP application; accessing second environmental metric data, by the hub application and from an environmental management computing system, the second environmental metric data describing an environmental metric associated with a plurality of transaction entries from the set of transaction entries; and writing, by the hub application, an environmental ledger entry to an environmental ledger table, the environmental ledger entry describing the plurality of transaction entries and the second environmental metric.

In Example 5, the subject matter of any one or more of Examples 1-4 optionally includes operations further comprising: accessing, by a hub application, a set of transaction entries from the universal journal table, the set of transaction entries comprising the first transaction entry, the hub application being distinct from the ERP application; determining, by the hub application, a subset of the set of transaction entries that are associated with at least one environmental metric at the component breakdown table; generating, by the hub application, an aggregate environmental metric, the aggregate environmental metric being based at least in part on a plurality of environmental metrics from the at least one environmental metric; and writing, by the hub application, an environmental ledger entry to an environmental ledger table, the environmental ledger entry describing the plurality of environmental metrics and the subset of the set of transaction entries.

In Example 6, the subject matter of any one or more of Examples 1-5 optionally includes operations further comprising: accessing, by a hub application, a general environmental metric, the general environmental metric being associated with the enterprise over a first time period, the hub application being distinct from the ERP application; allocating, by the hub application, the general environmental metric to at least one account; and writing, by the hub application, an environmental ledger entry to an environmental ledger table, the environmental ledger entry describing the general environmental metric and the at least one account.

In Example 7, the subject matter of any one or more of Examples 1-6 optionally includes the first transaction data further comprising a second environmental metric associated with the first component, the operations further comprising writing, by the ERP application, a second component breakdown entry to the component breakdown table of the database management system, the second component breakdown entry comprising an indication of the first component, a description of the second environmental metric, and the component breakdown key.

In Example 8, the subject matter of any one or more of Examples 1-7 optionally includes the first transaction data further comprising a constituent cost associated with the first component, the operations further comprising writing, by the ERP application, a second component breakdown entry to the component breakdown table of the database management system, the second component breakdown entry comprising an indication of the first component, a description of the constituent cost, and the component breakdown key.

Example 9 is a method of using a database management system to post a transaction, the method comprising: receiving, by an enterprise resource planning (ERP) application, first transaction data, the first transaction data associated with a first transaction including acquisition of a first component of a first component type, the first transaction data describing an indicator of the first component, a cost of the first component of a first component type, and a first environmental metric associated with the first component; writing, by the ERP application, a first transaction entry to a universal journal table of the database management system, the first transaction entry comprising a description of the first transaction, and a component breakdown key; and writing, by the ERP application, a first component breakdown entry to a component breakdown table of the database management system, the component breakdown entry comprising a first field indicating the component breakdown key, a second field indicating the first component, and a third field indicating the environmental metric associated with the first component.

In Example 10, the subject matter of Example 9 optionally includes receiving second transaction data, the second transaction data associated with a second transaction including a second component of the first component type; and writing, to the universal journal table of the database management system, a second transaction entity comprising an indication of the second component and the component breakdown key.

In Example 11, the subject matter of any one or more of Examples 9-10 optionally includes after writing the first component breakdown entry to the component breakdown table, receiving an updated first environmental metric associated with the first component; and updating the first component breakdown entry based on the updated first environmental metric.

In Example 12, the subject matter of any one or more of Examples 9-11 optionally includes accessing, by a hub application, a set of transaction entries from the universal journal table, the set of transaction entries being for transactions from a closed time period, the set of transaction entries comprising the first transaction entry, the hub application being distinct from the ERP application; accessing second environmental metric data, by the hub application and from an environmental management computing system, the second environmental metric data describing an environmental metric associated with a plurality of transaction entries from the set of transaction entries; and writing, by the hub application, an environmental ledger entry to an environmental ledger table, the environmental ledger entry describing the plurality of transaction entries and the second environmental metric.

In Example 13, the subject matter of any one or more of Examples 9-12 optionally includes accessing, by a hub application, a set of transaction entries from the universal journal table, the set of transaction entries comprising the first transaction entry, the hub application being distinct from the ERP application; determining, by the hub application, a subset of the set of transaction entries that are associated with at least one environmental metric at the component breakdown table; generating, by the hub application, an aggregate environmental metric, the aggregate environmental metric being based at least in part on a plurality of environmental metrics from the at least one environmental metric; and writing, by the hub application, an environmental ledger entry to an environmental ledger table, the environmental ledger entry describing the plurality of environmental metrics and the subset of the set of transaction entries.

In Example 14, the subject matter of any one or more of Examples 9-13 optionally includes accessing, by a hub application, a general environmental metric, the general environmental metric being associated with the enterprise over a first time period, the hub application being distinct from the ERP application; allocating, by the hub application, the general environmental metric to at least one account; and writing, by the hub application, an environmental ledger entry to an environmental ledger table, the environmental ledger entry describing the general environmental metric and the at least one account.

In Example 15, the subject matter of any one or more of Examples 9-14 optionally includes the first transaction data further comprising a second environmental metric associated with the first component, the method further comprising writing, by the ERP application, a second component breakdown entry to the component breakdown table of the database management system, the second component breakdown entry comprising an indication of the first component, a description of the second environmental metric, and the component breakdown key.

In Example 16, the subject matter of any one or more of Examples 9-15 optionally includes the first transaction data further comprising a constituent cost associated with the first component, the method further comprising writing, by the ERP application, a second component breakdown entry to the component breakdown table of the database management system, the second component breakdown entry comprising an indication of the first component, a description of the constituent cost, and the component breakdown key.

Example 17 is a non-transitory machine-readable medium comprising instructions thereon that, when executed by at least one processor, cause the at least one processor programmed to perform operations comprising: executing an enterprise resource planning (ERP) application; receiving, by the ERP application, first transaction data, the first transaction data associated with a first transaction including acquisition of a first component of a first component type, the first transaction data describing an indicator of the first component, a cost of the first component of a first component type, and a first environmental metric associated with the first component; writing, by the ERP application, a first transaction entry to a universal journal table of a database management system, the first transaction entry comprising a description of the first transaction, and a component breakdown key; and writing, by the ERP application, a first component breakdown entry to a component breakdown table of the database management system, the component breakdown entry comprising a first field indicating the component breakdown key, a second field indicating the first component, and a third field indicating the environmental metric associated with the first component.

In Example 18, the subject matter of Example 17 optionally includes operations further comprising: receiving second transaction data, the second transaction data associated with a second transaction including a second component of the first component type; and writing, to the universal journal table of the database management system, a second transaction entity comprising an indication of the second component and the component breakdown key.

In Example 19, the subject matter of any one or more of Examples 17-18 optionally includes operations further comprising: after writing the first component breakdown entry to the component breakdown table, receiving an updated first environmental metric associated with the first component; and updating the first component breakdown entry based on the updated first environmental metric.

In Example 20, the subject matter of any one or more of Examples 17-19 optionally includes operations further comprising: accessing, by a hub application, a set of transaction entries from the universal journal table, the set of transaction entries being for transactions from a closed time period, the set of transaction entries comprising the first transaction entry, the hub application being distinct from the ERP application; accessing second environmental metric data, by the hub application and from an environmental management computing system, the second environmental metric data describing an environmental metric associated with a plurality of transaction entries from the set of transaction entries; and writing, by the hub application, an environmental ledger entry to an environmental ledger table, the environmental ledger entry describing the plurality of transaction entries and the second environmental metric.

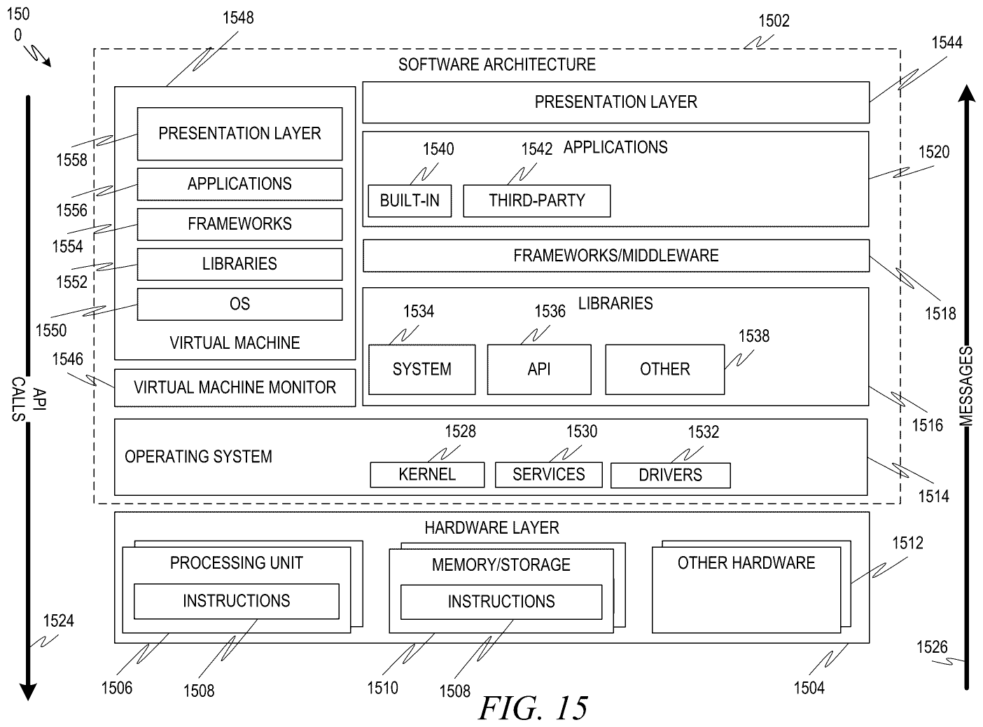

FIG. 15 is a block diagram 1500 showing one example of a software architecture 1502 for a computing device. The architecture 1502 may be used in conjunction with various hardware architectures, for example, as described herein. FIG. 15 is merely a non-limiting example of a software architecture and many other architectures may be implemented to facilitate the functionality described herein. A representative hardware layer 1504 is illustrated and can represent, for example, any of the above referenced computing devices. In some examples, the hardware layer 1504 may be implemented according to the architecture of the computer system of FIG. 15.

The representative hardware layer 1504 comprises one or more processing units 1506 having associated executable instructions 1508. Executable instructions 1508 represent the executable instructions of the software architecture 1502, including implementation of the methods, modules, subsystems, and components, and so forth described herein and may also include memory and/or storage modules 1510, which also have executable instructions 1508. Hardware layer 1504 may also comprise other hardware as indicated by other hardware 1512 which represents any other hardware of the hardware layer 1504, such as the other hardware illustrated as part of the architecture 1502.

In the example architecture of FIG. 15, the software architecture 1502 may be conceptualized as a stack of layers where each layer provides particular functionality. For example, the software architecture 1502 may include layers such as an operating system 1514, libraries 1516, middleware layer 1518 (also referred to as frameworks), applications 1520 and presentation layer 1544. Operationally, the applications 1520 and/or other components within the layers may invoke API calls 1524 through the software stack and access a response, returned values, and so forth illustrated as messages 1526 in response to the API calls 1524. The layers illustrated are representative in nature and not all software architectures have all layers. For example, some mobile or special purpose operating systems may not provide a middleware layer 1518, while others may provide such a layer. Other software architectures may include additional or different layers.

The operating system 1514 may manage hardware resources and provide common services. The operating system 1514 may include, for example, a kernel 1528, services 1530, and drivers 1532. The kernel 1528 may act as an abstraction layer between the hardware and the other software layers. For example, the kernel 1528 may be responsible for memory management, processor management (e.g., scheduling), component management, networking, security settings, and so on. The services 1530 may provide other common services for the other software layers. In some examples, the services 1530 include an interrupt service. The interrupt service may detect the receipt of an interrupt and, in response, cause the architecture 1502 to pause its current processing and execute an interrupt service routine (ISR) when an interrupt is accessed.

The drivers 1532 may be responsible for controlling or interfacing with the underlying hardware. For instance, the drivers 1532 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 1516 may provide a common infrastructure that may be utilized by the applications 1520 and/or other components and/or layers. The libraries 1516 typically provide functionality that allows other software modules to perform tasks in an easier fashion than to interface directly with the underlying operating system 1514 functionality (e.g., kernel 1528, services 1530 and/or drivers 1532). The libraries 1516 may include system 1534 libraries (e.g., C standard library) that may provide functions such as memory allocation functions, string manipulation functions, mathematic functions, and the like. In addition, the libraries 1516 may include API libraries 1536 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 1516 may also include a wide variety of other libraries 1538 to provide many other APIs to the applications 1520 and other software components/modules.

The middleware layer 1518 may provide a higher-level common infrastructure that may be utilized by the applications 1520 and/or other software components/modules. For example, the middleware layer 1518 may provide various graphic user interface (GUI) functions, high-level resource management, high-level location services, and so forth. The middleware layer 1518 may provide a broad spectrum of other APIs that may be utilized by the applications 1520 and/or other software components/modules, some of which may be specific to a particular operating system or platform.

The applications 1520 includes built-in applications 1540 and/or third party applications 1542. Examples of representative built-in applications 1540 may include, but are not limited to, a contacts application, a browser application, a book reader application, a location application, a media application, a messaging application, and/or a game application. Third party applications 1542 may include any of the built in applications as well as a broad assortment of other applications. In a specific example, the third party application 1542 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third party application 1542 may invoke the API calls 1524 provided by the mobile operating system such as operating system 1514 to facilitate functionality described herein.

The applications 1520 may utilize built in operating system functions (e.g., kernel 1528, services 1530 and/or drivers 1532), libraries (e.g., system 1534, API libraries 1536, and other libraries 1538), middleware layer 1518 to create UIs to interact with users of the system. Alternatively, or additionally, in some systems interactions with a user may occur through a presentation layer, such as presentation layer 1544. In these systems, the application/module “logic” can be separated from the aspects of the application/module that interact with a user.

Some software architectures utilize virtual machines. In the example of FIG. 15, this is illustrated by virtual machine 1548. A virtual machine creates a software environment where applications/modules can execute as if they were executing on a hardware computing device. A virtual machine is hosted by a host operating system (operating system 1514) and typically, although not always, has a virtual machine monitor 1546, which manages the operation of the virtual machine as well as the interface with the host operating system (i.e., operating system 1514). A software architecture executes within the virtual machine such as an operating system 1550, libraries 1552, frameworks/middleware 1554, applications 1556 and/or presentation layer 1558. These layers of software architecture executing within the virtual machine 1548 can be the same as corresponding layers previously described or may be different.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client, or server computer system) or one or more hardware processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or another programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs).

The description herein includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques have not been shown in detail.

### Electronic Apparatus and System

Example embodiments may be implemented in digital electronic circuitry, or in computer hardware, firmware, or software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., an FPGA or an ASIC.

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out hardware (e.g., machine) and software architectures that may be deployed, in various example embodiments.

### Example Machine Architecture and Machine-Readable Medium

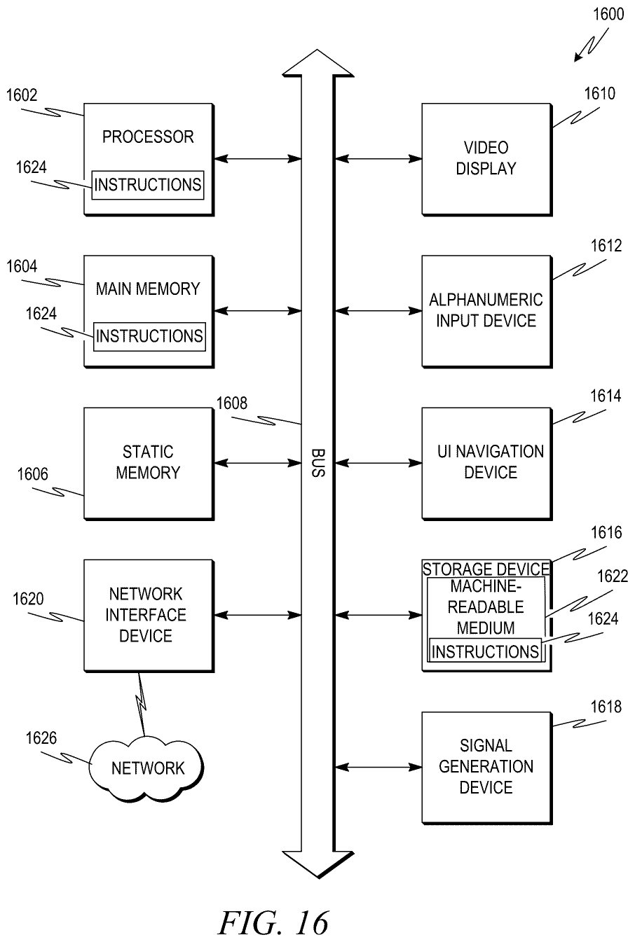

FIG. 16 is a block diagram of a machine in the example form of a computer system 1600 within which instructions 1624 may be executed for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1600 includes a processor 1602 (e.g., a central processing unit (CPU), a graphics processing unit (GPU), or both), a main memory 1604, and a static memory 1606, which communicate with each other via a bus 1608. The computer system 1600 may further include a video display unit 1610 (e.g., a liquid crystal display (LCD) or a cathode ray tube (CRT)). The computer system 1600 also includes an alphanumeric input device 1612 (e.g., a keyboard or a touch-sensitive display screen), a UI navigation (or cursor control) device 1614 (e.g., a mouse), a disk drive unit 1616, a signal generation device 1618 (e.g., a speaker), and a network interface device 1620.

### Machine-Readable Medium

The disk drive unit 1616 includes a machine-readable medium 1622 on which is stored one or more sets of data structures and instructions 1624 (e.g., software) embodying or utilized by any one or more of the methodologies or functions described herein. The instructions 1624 may also reside, completely or at least partially, within the main memory 1604 and/or within the processor 1602 during execution thereof by the computer system 1600, with the main memory 1604 and the processor 1602 also constituting machine-readable media 1622.

While the machine-readable medium 1622 is shown in an example embodiment to be a single medium, the term “machine-readable medium” may include a single medium or multiple media (e.g., a centralized or distributed database, and/or associated caches and servers) that store the one or more instructions 1624 or data structures. The term “machine-readable medium” shall also be taken to include any tangible medium that is capable of storing, encoding, or carrying instructions 1624 for execution by the machine and that cause the machine to perform any one or more of the methodologies of the present disclosure, or that is capable of storing, encoding, or carrying data structures utilized by or associated with such instructions 1624. The term “machine-readable medium” shall accordingly be taken to include, but not be limited to, solid-state memories, and optical and magnetic media. Specific examples of machine-readable media 1622 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks.

### Transmission Medium

The instructions 1624 may further be transmitted or received over a communications network 1626 using a transmission medium. The instructions 1624 may be transmitted using the network interface device 1620 and any one of a number of well-known transfer protocols (e.g., HTTP). Examples of communication networks include a LAN, a WAN, the Internet, mobile telephone networks, plain old telephone (POTS) networks, and wireless data networks (e.g., WiFi and WiMax networks). The term “transmission medium” shall be taken to include any intangible medium that is capable of storing, encoding, or carrying instructions 1624 for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A system for using a database management system to post a transaction, comprising:
at least one processor programmed to perform operations comprising:
executing an enterprise resource planning (ERP) application;
receiving, by the ERP application, first transaction data, the first transaction data associated with a first transaction including acquisition of a first component of a first component type, the first transaction data describing an indicator of the first component, a cost of the first component of a first component type, and a first environmental metric associated with the first component;
writing, by the ERP application, a first transaction entry to a universal journal table of the database management system, the first transaction entry comprising a description of the first transaction and a component breakdown key; and
writing, by the ERP application, a first component breakdown entry to a component breakdown table of the database management system, the component breakdown entry comprising a first field indicating the component breakdown key, a second field indicating the first component, and a third field indicating the environmental metric associated with the first component.

2. The system of claim 1, operations further comprising:
receiving second transaction data, the second transaction data associated with a second transaction including a second component of the first component type; and
writing, to the universal journal table of the database management system, a second transaction entity comprising an indication of the second component and the component breakdown key.

3. The system of claim 1, operations further comprising:
after writing the first component breakdown entry to the component breakdown table, receiving an updated first environmental metric associated with the first component; and
updating the first component breakdown entry based on the updated first environmental metric.

4. The system of claim 1, operations further comprising:
accessing, by a hub application, a set of transaction entries from the universal journal table, the set of transaction entries being for transactions from a closed time period, the set of transaction entries comprising the first transaction entry, the hub application being distinct from the ERP application;
accessing second environmental metric data, by the hub application and from an environmental management computing system, the second environmental metric data describing an environmental metric associated with a plurality of transaction entries from the set of transaction entries; and
writing, by the hub application, an environmental ledger entry to an environmental ledger table, the environmental ledger entry describing the plurality of transaction entries and the second environmental metric.

5. The system of claim 1, operations further comprising:
accessing, by a hub application, a set of transaction entries from the universal journal table, the set of transaction entries comprising the first transaction entry, the hub application being distinct from the ERP application;
determining, by the hub application, a subset of the set of transaction entries that are associated with at least one environmental metric at the component breakdown table;
generating, by the hub application, an aggregate environmental metric, the aggregate environmental metric being based at least in part on a plurality of environmental metrics from the at least one environmental metric; and
writing, by the hub application, an environmental ledger entry to an environmental ledger table, the environmental ledger entry describing the plurality of environmental metrics and the subset of the set of transaction entries.

6. The system of claim 1, operations further comprising:
accessing, by a hub application, a general environmental metric, the general environmental metric being associated with the enterprise over a first time period, the hub application being distinct from the ERP application;
allocating, by the hub application, the general environmental metric to at least one account; and
writing, by the hub application, an environmental ledger entry to an environmental ledger table, the environmental ledger entry describing the general environmental metric and the at least one account.

7. The system of claim 1, the first transaction data further comprising a second environmental metric associated with the first component, the operations further comprising writing, by the ERP application, a second component breakdown entry to the component breakdown table of the database management system, the second component breakdown entry comprising an indication of the first component, a description of the second environmental metric, and the component breakdown key.

8. The system of claim 1, the first transaction data further comprising a constituent cost associated with the first component, the operations further comprising writing, by the ERP application, a second component breakdown entry to the component breakdown table of the database management system, the second component breakdown entry comprising an indication of the first component, a description of the constituent cost, and the component breakdown key.

9. A method of using a database management system to post a transaction, the method comprising:
receiving, by an enterprise resource planning (ERP) application, first transaction data, the first transaction data associated with a first transaction including acquisition of a first component of a first component type, the first transaction data describing an indicator of the first component, a cost of the first component of a first component type, and a first environmental metric associated with the first component;
writing, by the ERP application, a first transaction entry to a universal journal table of the database management system, the first transaction entry comprising a description of the first transaction, and a component breakdown key; and
writing, by the ERP application, a first component breakdown entry to a component breakdown table of the database management system, the component breakdown entry comprising a first field indicating the component breakdown key, a second field indicating the first component, and a third field indicating the environmental metric associated with the first component.

10. The method of claim 9, further comprising:
receiving second transaction data, the second transaction data associated with a second transaction including a second component of the first component type; and
writing, to the universal journal table of the database management system, a second transaction entity comprising an indication of the second component and the component breakdown key.

11. The method of claim 9, further comprising:
after writing the first component breakdown entry to the component breakdown table, receiving an updated first environmental metric associated with the first component; and
updating the first component breakdown entry based on the updated first environmental metric.

12. The method of claim 9, further comprising:
accessing, by a hub application, a set of transaction entries from the universal journal table, the set of transaction entries being for transactions from a closed time period, the set of transaction entries comprising the first transaction entry, the hub application being distinct from the ERP application;
accessing second environmental metric data, by the hub application and from an environmental management computing system, the second environmental metric data describing an environmental metric associated with a plurality of transaction entries from the set of transaction entries; and
writing, by the hub application, an environmental ledger entry to an environmental ledger table, the environmental ledger entry describing the plurality of transaction entries and the second environmental metric.

13. The method of claim 9, further comprising:
accessing, by a hub application, a set of transaction entries from the universal journal table, the set of transaction entries comprising the first transaction entry, the hub application being distinct from the ERP application;
determining, by the hub application, a subset of the set of transaction entries that are associated with at least one environmental metric at the component breakdown table;
generating, by the hub application, an aggregate environmental metric, the aggregate environmental metric being based at least in part on a plurality of environmental metrics from the at least one environmental metric; and
writing, by the hub application, an environmental ledger entry to an environmental ledger table, the environmental ledger entry describing the plurality of environmental metrics and the subset of the set of transaction entries.

14. The method of claim 9, further comprising:
accessing, by a hub application, a general environmental metric, the general environmental metric being associated with the enterprise over a first time period, the hub application being distinct from the ERP application;
allocating, by the hub application, the general environmental metric to at least one account; and
writing, by the hub application, an environmental ledger entry to an environmental ledger table, the environmental ledger entry describing the general environmental metric and the at least one account.

15. The method of claim 9, the first transaction data further comprising a second environmental metric associated with the first component, the method further comprising writing, by the ERP application, a second component breakdown entry to the component breakdown table of the database management system, the second component breakdown entry comprising an indication of the first component, a description of the second environmental metric, and the component breakdown key.

16. The method of claim 9, the first transaction data further comprising a constituent cost associated with the first component, the method further comprising writing, by the ERP application, a second component breakdown entry to the component breakdown table of the database management system, the second component breakdown entry comprising an indication of the first component, a description of the constituent cost, and the component breakdown key.

17. A non-transitory machine-readable medium comprising instructions thereon that, when executed by at least one processor, cause the at least one processor programmed to perform operations comprising:
executing an enterprise resource planning (ERP) application;
receiving, by the ERP application, first transaction data, the first transaction data associated with a first transaction including acquisition of a first component of a first component type, the first transaction data describing an indicator of the first component, a cost of the first component of a first component type, and a first environmental metric associated with the first component;
writing, by the ERP application, a first transaction entry to a universal journal table of a database management system, the first transaction entry comprising a description of the first transaction, and a component breakdown key; and
writing, by the ERP application, a first component breakdown entry to a component breakdown table of the database management system, the component breakdown entry comprising a first field indicating the component breakdown key, a second field indicating the first component, and a third field indicating the environmental metric associated with the first component.

18. The medium of claim 17, operations further comprising:
receiving second transaction data, the second transaction data associated with a second transaction including a second component of the first component type; and
writing, to the universal journal table of the database management system, a second transaction entity comprising an indication of the second component and the component breakdown key.

19. The medium of claim 17, operations further comprising:
after writing the first component breakdown entry to the component breakdown table, receiving an updated first environmental metric associated with the first component; and
updating the first component breakdown entry based on the updated first environmental metric.

20. The medium of claim 17, operations further comprising:
accessing, by a hub application, a set of transaction entries from the universal journal table, the set of transaction entries being for transactions from a closed time period, the set of transaction entries comprising the first transaction entry, the hub application being distinct from the ERP application;
accessing second environmental metric data, by the hub application and from an environmental management computing system, the second environmental metric data describing an environmental metric associated with a plurality of transaction entries from the set of transaction entries; and
writing, by the hub application, an environmental ledger entry to an environmental ledger table, the environmental ledger entry describing the plurality of transaction entries and the second environmental metric.
